(19) United States
(12) Patent Application Publication
(10) Pub. No.: US 2005/0204884 A1
(43) Pub. Date: Sep. 22, 2005

(54) Table saw having measuring means

(75) Inventor: Peter Huang, Taichung (TW)

Correspondence Address: BACON & THOMAS, PLLC, 625 SLATERS LANE, FOURTH FLOOR, ALEXANDRIA, VA, 22314, US

(73) Assignee: DURQ MACHINERY CORP., TAICHUNG (TW)

(21) Appl. No.: 10/893,362

(22) Filed: Jul. 19, 2004

(30) Foreign Application Priority Data
Mar. 16, 2004 (TW) 93203986

(51) Int. Cl. B23D 45/06

(52) U.S. Cl. 83/477.2; 83/522.19

(57) ABSTRACT

A table saw includes a primary table, an auxiliary table moveable relative to the primary table, a detachable fence movable on the primary table and the auxiliary table, a first ruler and a second ruler, which are arranged at one side of the primary table and have respectively readings increased in value in same direction, a first pointer movable with the fence for pointing out the readings on the first ruler, and a second pointer movable with the auxiliary table for pointing out the readings on the second ruler after the fence has been locked to the auxiliary table.

### BACKGROUND OF THE INVENTION

1. Field of the Invention

The present invention relates to a sawing machine and more particularly, to a table saw having measuring means.

2. Description of the Related Art

FIG. 1 shows a table saw according to the prior art. According to this design, the table saw comprises a table 1, two rails 2 provided at two sides of the table 1, two sliding hollow bars 3 respectively sleeved onto the rails 2, two rulers 3a, 3b arranged in parallel on one sliding bar 3, a fence 4 connected between the sliding bars 3 at the top, a L-shaped bracket 5 pivoted to the fence 4, a saw blade 6, and an index system 7. When pulled the fence 4 out of the table 1, the L-shaped bracket 5 is turned to a horizontal position and rested on the two sliding bar 3 for supporting a long workpiece (for example, wooden bar). On the contrary, when wishing to move the fence 4 toward the saw blade 6, the user must turn the L-shaped bracket 5 upwards from the sliding bar 3 to a vertical position (see the imaginary line shown in FIG. 1) for enabling the fence 4 to be moved to the table 1. The index system 7 is fixedly provided at one side of the table 1, comprising two windows 7a, 7b and two pointers 7c, 7d. Through the window 7a or 7b, the user can see the reading of the ruler 3a or 3b indicated by the pointer 7c or 7d, which reading is indicative of the distance between the fence 4 and the saw blade 6.

The aforesaid dual-ruler dual-pointer measuring system can be used to indicate different cutting lengths; however, the L-shaped bracket 5 may be forced to fall suddenly from the vertical position to the horizontal position by an external force (impact or vibration) during sawing operation, thereby causing a trouble accident.

Further, the aforesaid dual-ruler dual-pointer measuring system limits the positioning of the fence, i.e., the fence can only be installed in one side of the table. When changing the position of the fence to the other side of the table, the dual-ruler dual-pointer measuring system becomes unable to indicate the distance between the fence and the saw blade.

Therefore, it is desirable to provide a table saw having measuring means that eliminates the aforesaid problem.

### SUMMARY OF THE INVENTION

The present invention has been accomplished under the circumstances in view. It is the primary objective of the present invention to provide a table saw having measuring means, which is easy and convenient to use.

It is another objective of the present invention to provide a table saw having measuring means, which allows the fence to be selectively installed in either of the two opposite lateral sides of the table without affecting normal functioning of the measuring means.

To achieve these objectives of the present invention, the table saw comprises a saw base, a primary table supported on the saw base, an auxiliary table, a fence, a first ruler, a first pointer, a second ruler, and a second pointer. The primary table has a top surface and an opening through which a saw blade extends. The auxiliary table is movable relative to the primary table between a received position where the auxiliary table abuts against the primary table and an extended position where the auxiliary table is positional apart from the primary table. The auxiliary table has a top surface. The fence is movable on the top surfaces of the primary and auxiliary tables relative to the saw blade. The first ruler has a start point, an end point and readings increasing in value in a direction from the start point toward the end point. The first pointer is provided at the fence for pointing out the readings on the first ruler. The second ruler is arranged in parallel and adjacent to the first ruler. The second ruler has a start point, an end point, and readings increasing in value in a direction from the start point of the second ruler toward the end point of the second ruler. The reading of the start point of the second ruler is equal to that of the end point of the first ruler. The increasing direction of the readings of the second ruler in value is same as the increasing direction of the readings of the first ruler in value. The second pointer is movable with the auxiliary table for pointing out the readings on the second ruler.

### BRIEF DESCRIPTION OF THE DRAWINGS

FIG. 1 is a schematic perspective view of a table saw according to the prior art.

FIG. 2 is a perspective view of a table saw according to the present invention.

FIG. 3 is another perspective view of the table saw according to the present invention.

FIG. 4 is a top view of the present invention, showing the received status of the auxiliary table of the table saw.

FIG. 5 is a schematic drawing showing the locking status of the fence according to the present invention.

FIG. 6 is similar to FIG. 5 but showing the fence unlocked.

FIG. 7 is an enlarged view of part A of FIG. 4.

FIG. 8 is an enlarged view of part B of FIG. 4.

FIG. 9 is an enlarged view of part C of FIG. 4.

FIG. 10 is an enlarged view of part D of FIG. 4.

FIG. 11 is a top view of the present invention showing the received status of the auxiliary table of the table saw and the fence locked to the auxiliary table.

FIG. 12 is an enlarged view of part E of FIG. 11.

FIG. 13 is a top view of the present invention showing the fence locked to the auxiliary table and the auxiliary table moved to an extended position.

FIG. 14 is an enlarged view of part F of FIG. 13.

FIG. 15 is a top view of the present invention showing the fence locked to the primary table and the auxiliary table moved to an extended position.

FIG. 16 is a top view of the present invention showing the fence locked to the primary table and disposed at the other side relative to the saw blade.

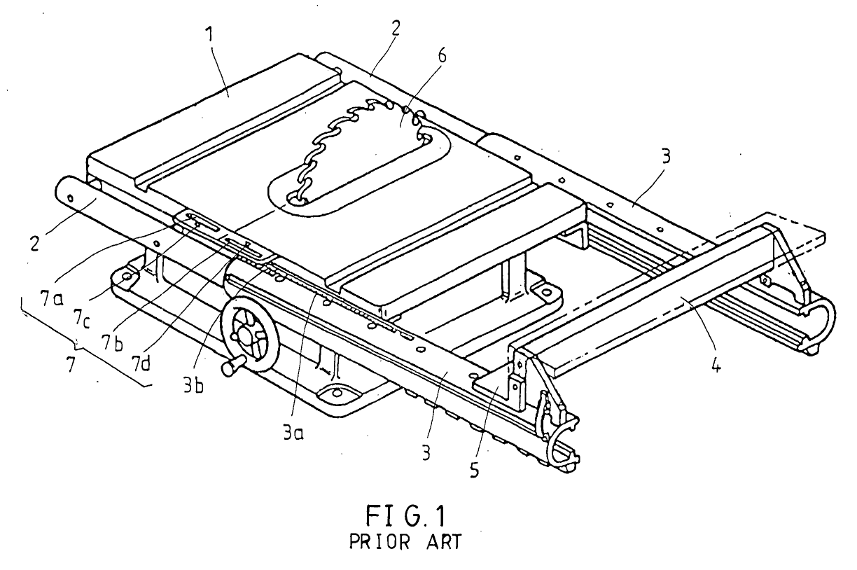

### DETAILED DESCRIPTION OF THE INVENTION

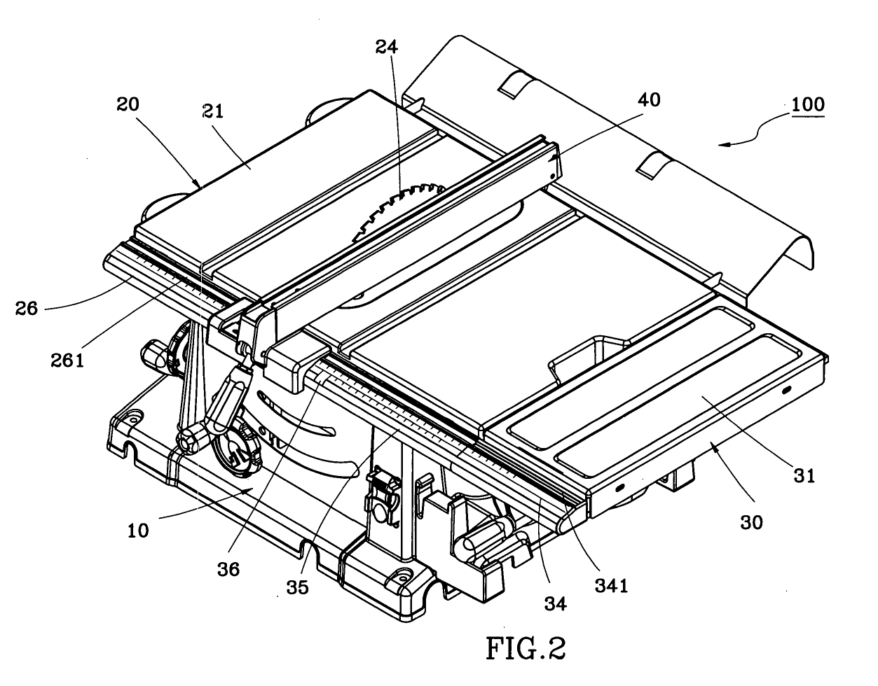

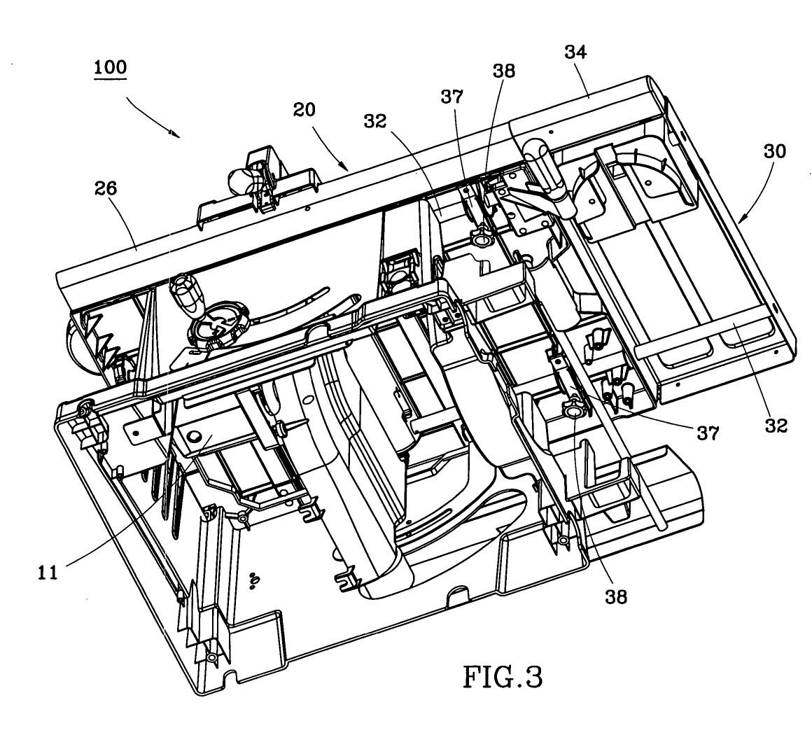

Referring to FIGS. 2-4, a table saw 100 provided by the present invention is shown comprising a saw base 10, a primary table 20, an auxiliary table 30 and a fence 40.

The saw base 10 is installed with a motor 11 inside. The primary table 20 is fixedly supported on the saw base 10 and has a top surface 21 and an opening 22 through which a saw blade 24 that is rotatably actuated by the motor 11 extends. A first side bar 26 is fixedly fastened to the front side of the primary table 20 and extended to the two distal ends of the front side of the primary table 20. The first side bar 26 has a groove 261 extended along the length thereof in parallel to the front side of the primary table 20.

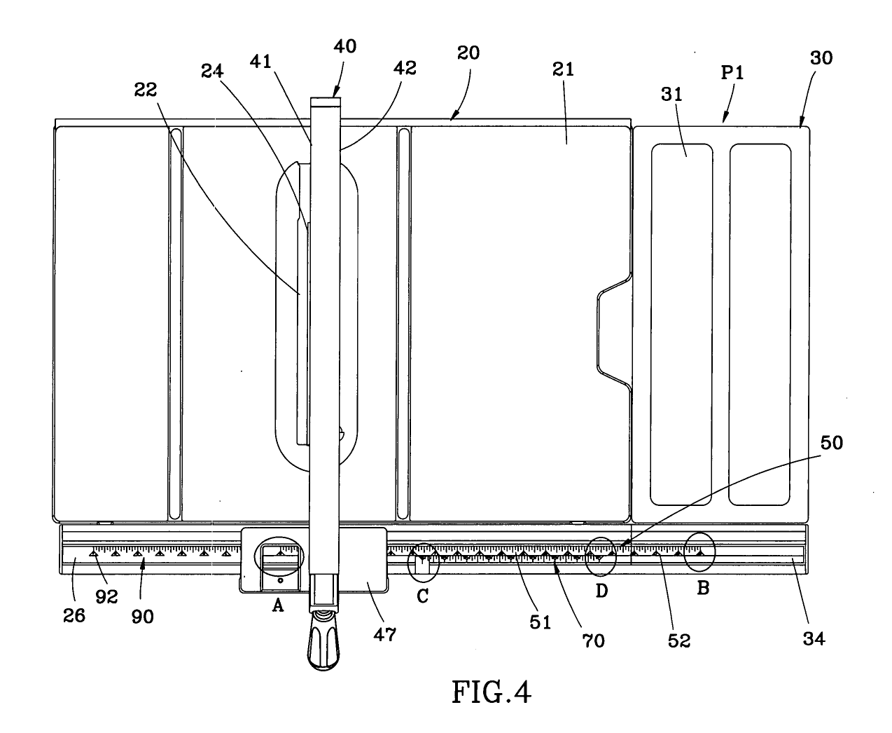

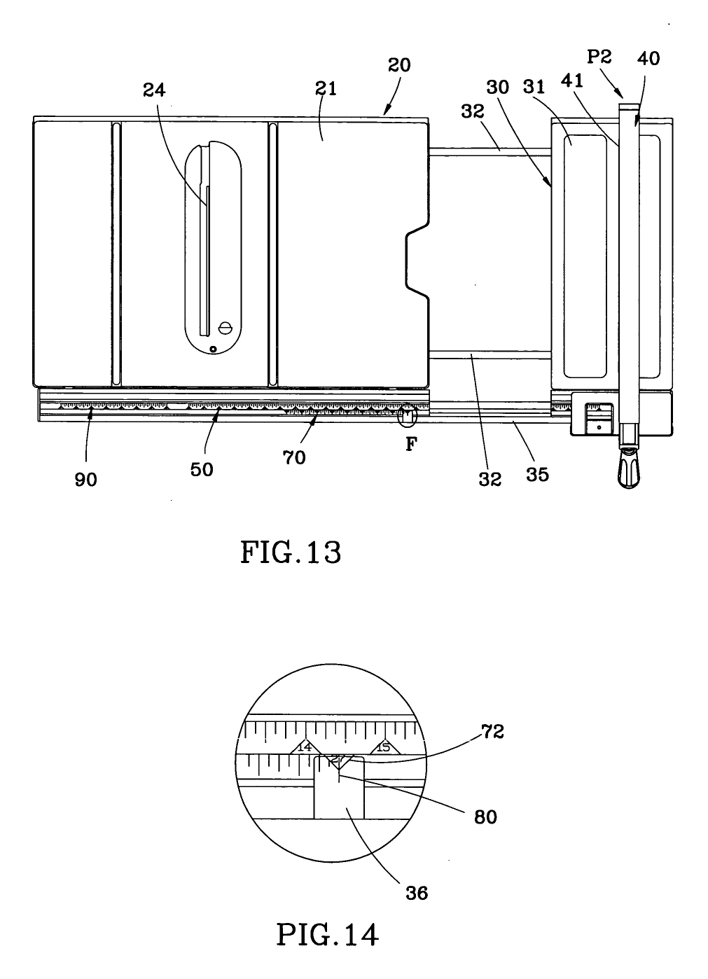

The auxiliary table 30 is a rectangular plate member and has an area smaller than that of the primary table 20. The auxiliary table includes a top surface 31, and two parallel bottom guiding rods 32, which are slidably coupled to the bottom side of the primary table 20 in such a manner that the auxiliary table 30 can be moved between a received position P1 as shown in FIG. 4 where the auxiliary table 30 is abutted against one side of the primary table 20 and the top surface 31 is maintained in flush with the top surface 21, and an extended position P2 as shown in FIG. 13 where the auxiliary table is apart from the primary table 20. A second side bar 34 is fixedly fastened to the front side of the auxiliary table 30 and extended to the two distal ends of the front side of the auxiliary table 30. The second side bar 34 has a groove 341 which is extended along the length thereof in parallel to the front side of the auxiliary table 30.

A link 35 is arranged in parallel to the front side of the primary table 20. The link 35 has a first end fixedly connected to the auxiliary table 30 for synchronous movement with the auxiliary table 30 and the other end extending toward the primary table 20 to a position corresponding to the saw blade 24 when the auxiliary table is positioned at the received position P1. The other end of the link 35 is provided with a transparent block 36.

A lock for locking the auxiliary table 30 comprises two locating members, for example, two locating plates 37 provided at the bottom side of the primary table 20 and respectively extended over and pressed on the guiding rods 32, and two locking members, for example, tightening up screws 38 respectively inserted through the locating plates 37 and screwed into the bottom side of the primary table 20 such that the screws 38 can firmly fasten the locating plates 37 to the bottom side of the primary table 20 so as to further lock the auxiliary table 30.

The fence 40 is moveable on the top surface 21 of the primary table 20 and the top surface 31 of the auxiliary table 30. As shown in FIG. 2 and FIG. 4, the fence 40 is placed on the primary table 20 and has first and second upright sidewalls 41,42 arranged in parallel with each other and perpendicular to the front side of the primary table 20.

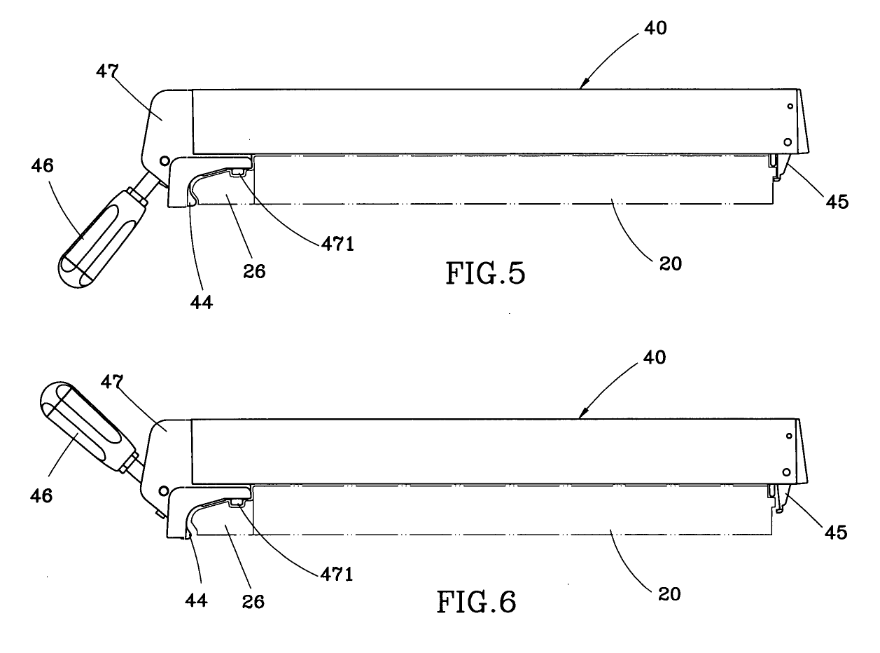

A clamping mechanism is applied for locking the fence 40 to the primary table 20 or the auxiliary table 30 selectively. Referring to FIGS. 5 and 6, the clamping mechanism comprises first and second claws 44, 45 respectively provided at the two ends of the fence 40 and facing downwards, and a handle 46 pivotally fastened to a sliding block 47 that is connected to an end of the fence 40 for moving the claws 44, 45 between a clamped position and a released position by a linkage (not shown) provided inside the fence 40 and linked between the claws 44, 45 and the handle 46. The sliding block 47 is movable along the first side bar 26 and the second side bar 34 upon the moment of the fence 40 and the sliding block 47 has a bottom tongue 471 fitting the grooves 261, 341 for guiding movement of the sliding bloc 47 along the first side bar 26 and the second side bar 34.

FIG. 5 shows the first claw 44 clamped on the first side bar 26 and the second claw 45 clamped on the rear side of the primary table 20 such that the fence 40 is locked to the primary table 20 in a desired position. Similarly, the first claw 44 and the second claw 45 can respectively clamp the second side bar 34 and the rear side of the auxiliary table 30 so as to lock the fence 40 to the auxiliary table 30 in a desired position.

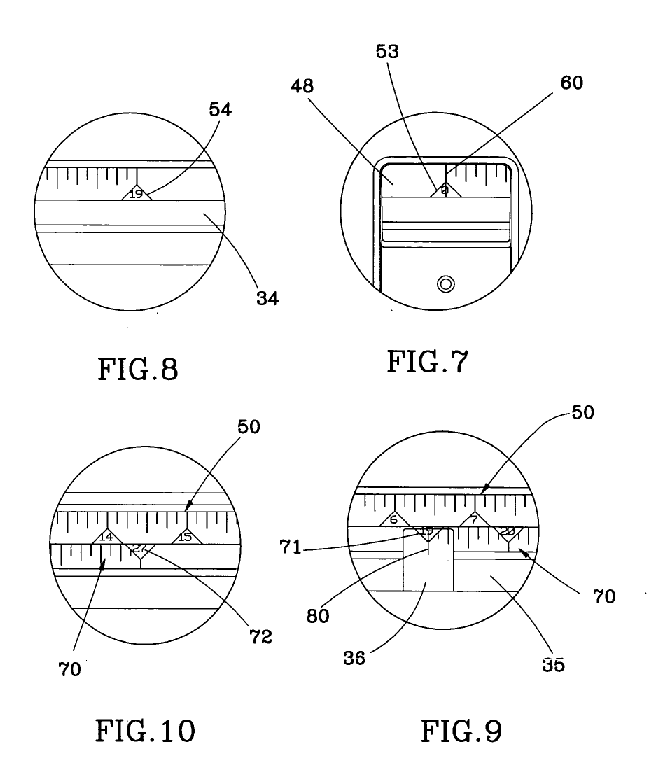

When released the claws 44,45 as shown in FIG. 6, the fence 40 can be moved with the sliding block 47 along the first side bar 26 and the second side bar 34 and then lock to the primary table 20 or the auxiliary table 30 as desired. Further, the fence 40 can be removed with the sliding block 47 from the table saw and received in a storage space. Further, the sliding block 47 has a transparent window 48 (see FIG. 7).

The table saw 100 further comprises a first ruler 50, a first pointer 60, a second ruler 70, a second pointer 80 and a third ruler 90.

The first ruler 50 is an inch system, having a front half inch mark section 51, a rear half inch mark section 52, a true-zero start point 53 and an end point 54. The readings of the inch marks of the first ruler 50 increase in value from the true-zero start point 53 of the front half inch mark section 51 toward the end point 54 of the rear half inch mark section 52. The front half inch mark section 51 is provided at the surface of the first side bar 26. The true-zero start point 53 is the zero reading of the front half inch mark section 51 set close to the saw blade 24 (see FIG. 7). The rear half inch mark section 52 is provided at the surface of the second side bar 34. The end point 54 is the inch mark “19” set at the end of the rear half inch mark section 52 remote from the front half inch mark section 51 (see FIG. 8).

The first pointer 60 is marked on the window 48 (see FIG. 7), and adapted to point a reading out on the first ruler 50.

The second ruler 70 is an inch system provided at the first side bar 26 adjacent to the first ruler 50, having a start point 71 and an end point 72. The reading of the start point 71 of the second ruler 70 is equal to the reading of the end point 54 of the first ruler 50. The reading of the end point 72 of the second ruler 70 is “27” (see FIG. 10). Further, the readings of the second ruler 70 increase in value from the left end thereof toward the right end thereof. In other words, the increasing direction of the readings of the second ruler 70 in value is same as that of the first ruler 50.

The second pointer 80 is marked on the transparent block 36 at the link 35 (see FIG. 9), and adapted to point a reading out on the second ruler 70.

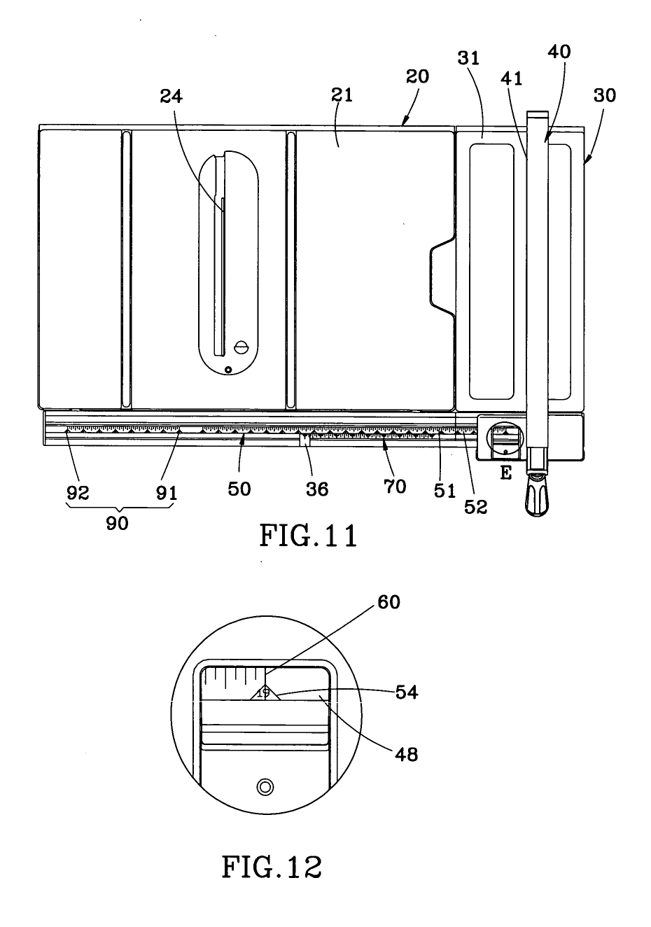

The third ruler 90 is provided at the surface of the first side bar 26 in axial alignment with the first ruler 50. The third ruler 90 has a start point 91 (see FIG. 11) at the right end thereof, and an end point 92 at the left end thereof. The increasing direction of the readings of the third ruler 90 in value is from the right end toward the left end, which is reversed to the increasing direction of the readings of the first ruler 50.

The aforesaid statement describes the structures of the parts of the table saw 100 and their relative positioning. FIG. 4 shows zero distance between the first upright sidewall 41 of the fence 40 and the saw blade 24. At this time, the user can see the zero reading indicated by the first pointer 60 as shown in FIG. 7.

When shifted the fence 40 to the auxiliary table 30 and locked, the user can know the distance between the first upright sidewall 41 of the fence 40 and the saw blade 24 subject to the indication of the first pointer 60. As shown in FIGS. 11 and 12, the first pointer 60 points out the reading on the end point 54 of the first ruler 50 to be “19”. After the fence 40 has been locked to the auxiliary table 30, the user can pull the auxiliary table 30 and the fence 40 outwards from the primary table 20. At this time, the user can know the distance between the first upright sidewall 41 of the fence 40 and the saw blade 24 subject to the indication of the second pointer 80. As shown in FIGS. 13 and 14, the second pointer 80 points out the reading on the second ruler 70 to be “27”.

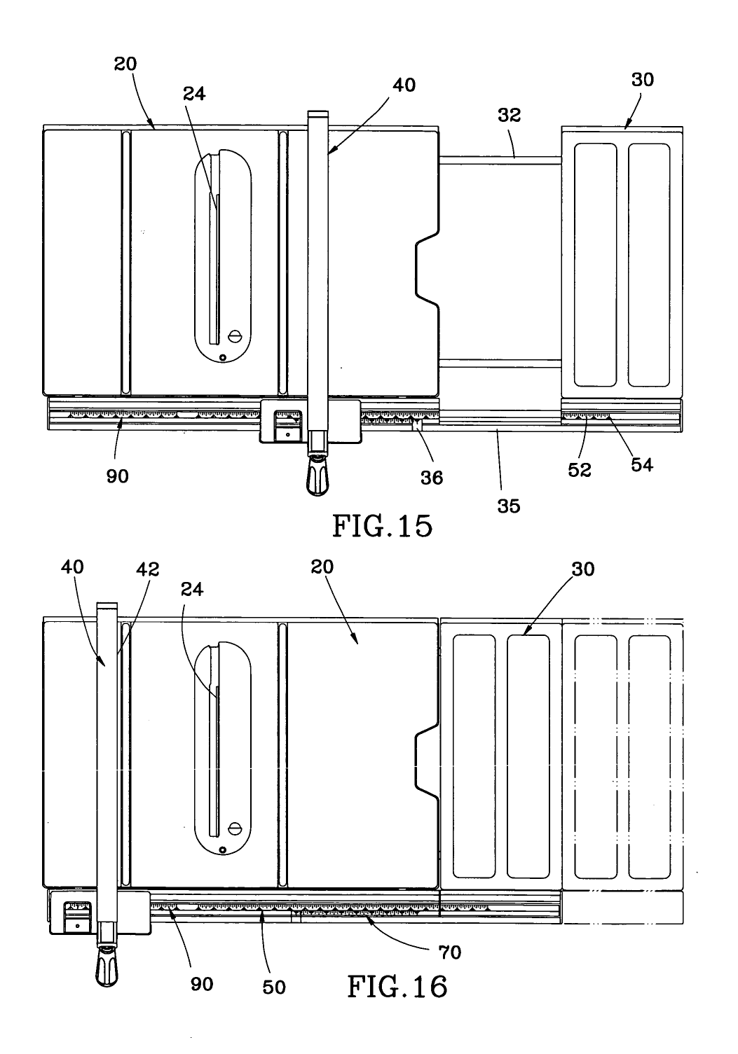

Further, when wishing to cut a small workpiece shorter than 19 inches under the status shown in FIG. 13, the user can shift the fence 40 from the auxiliary table 30 to the primary table 20 without moving the auxiliary table 30 relative to the primary table 20 (see FIG. 15). In the same way, the fence 40 can be shifted to the other side of the saw blade 24 without lowering the saw blade 24 as shown in FIG. 16. In this case, the user can know the distance between the second upright sidewall 42 of the fence 40 and the saw blade 24 subject to the indication of the first pointer 60 at the third ruler 90.

Although a particular embodiment of the invention has been described in detail for purposes of illustration, various modifications and enhancements may be made without departing from the spirit and scope of the invention. Accordingly, the invention is not to be limited except as by the appended claims.

1. A table saw comprising:
a saw base;
a primary table supported on said saw base, said primary table having a top surface and an opening through which a saw blade extends;
an auxiliary table, which is movable relative to said primary table between a received position where said auxiliary table abuts against said primary table and an extended position where said auxiliary table is positional apart from said primary table, said auxiliary table having a top surface;
a fence movable on said top surface of said primary table and said top surface of said auxiliary table relative to said saw blade;
a first ruler having a start point, an end point, and readings increasing in value in a direction from the start point toward the end point;
a first pointer provided at said fence for pointing out the readings on said first ruler;
a second ruler arranged in parallel and adjacent to said first ruler, said second ruler having a start point, an end point, and readings increasing in value in a direction from the start point of said second ruler toward the end point of said second ruler, the reading of the start point of said second ruler being equal to that of the end point of the first ruler, the increasing direction of the readings of said second ruler in value being same as the increasing direction of the readings of said first ruler in value; and
a second pointer movable with said auxiliary table for pointing out the readings on said second ruler.

2. The table saw as claimed in claim 1, wherein said primary table has a front side fixedly mounted with a first side bar, said first side bar being extended along the front side of said primary table and having two distal ends not extended over two distal ends of the front side of said primary table; said auxiliary table has a front side fixedly mounted with a second side bar, said second side bar being extended along the front side of said auxiliary table and having two distal ends not extended over two distal ends of the front side of said auxiliary table; said first ruler comprises a front half section made on the surface of said first side bar, a rear half section made on the surface of said second side bar, and the readings made on said front half section and said rear half section and gradually increased in value from the start point of said first ruler to the end point of said first ruler, the start point of said first ruler being a true zero at one end of said front half section remote from said rear half section, the end point of said first ruler being at one end of said rear half section remote from said front half section.

3. The table saw as claimed in claim 2, wherein said second ruler is made on the surface of said first side bar.

4. The table saw as claimed in claim 2, further comprising a link set in parallel to the front side of said primary table, said link having a first end fixedly connected to said auxiliary table and a second end extending toward said primary table and having said second pointer made thereon.

5. The table saw as claimed in claim 2, further comprising a third ruler made on the surface of said first side bar, said third ruler having a start point, an end point, and readings increasing in value in a direction from the start point of said third ruler toward the end point of said third ruler; the increasing direction of the readings of said third ruler in value being reversed to that of the readings of said first ruler, said third ruler being indicatable by said first pointer when said fence is moved on said top surface of said primary table.

6. The table saw as claimed in claim 2, further comprising a clamping mechanism for locking said fence to said primary table or said auxiliary table.

7. The table saw as claimed in claim 6, wherein said clamping mechanism comprises two claws provided at two distal ends of said fence and facing downwards, and a handle for moving said claws between a locking position and an unlocking position.

8. The table saw as claimed in claim 2, further comprises a lock for locking said auxiliary table to the extended position away from said primary table.

9. The table saw as claimed in claim 1, wherein said first ruler comprises a front half section provided at said primary table, a rear half section provided at said auxiliary table, and the readings made on said front half section and said rear half section and gradually increased in value from the start point of said first ruler to the end point of said first ruler, the start point of said first ruler being a true zero at one end of said front half section remote from said rear half section, the end point of said first ruler being at one end of said rear half section remote from said front half section.
